(19) United States
(12) Patent Application Publication
(10) Pub. No.: US 2025/0048201 A1
(43) Pub. Date: Feb. 6, 2025

(54) RANDOM ACCESS IN LOWER-LAYER TRIGGERED MOBILITY PROCEDURE

(71) Applicant: Apple Inc., Cupertino, CA (US)

(72) Inventors: Hong He, San Jose, CA (US); Chunxuan Ye, San Diego, CA (US); Dan Wu, Beijing (CN); Dawei Zhang, Saratoga, CA (US); Huaning Niu, San Jose, CA (US); Jie Cui, San Jose, CA (US); Wei Zeng, Saratoga, CA (US)

(21) Appl. No.: 18/793,723

(22) Filed: Aug. 2, 2024

Related U.S. Application Data
(60) Provisional application No. 63/530,514, filed on Aug. 3, 2023.

(51) Int. Cl. H04W 36/00; H04W 36/08; H04W 52/36

(52) U.S. Cl. CPC H04W 36/0072; H04W 36/08; H04W 52/36

(57) ABSTRACT

A method for performing a contention-free random access (CFRA) in a lower-layer triggered mobility (LTM) procedure from a serving cell to a target candidate cell is provided. The method includes determining, by a user equipment (UE), that random access response (RAR) reception is not configured for the UE. The method includes receiving, by the UE, a physical downlink control channel (PDCCH) order for transmitting a physical random access channel (PRACH) signal to the target candidate cell. The method includes determining, by the UE and based on the PDCCH order, a transmission power for transmitting the PRACH signal.

### CROSS-REFERENCE TO RELATED APPLICATIONS

This application claims priority to U.S. Provisional Patent Application No. 63/530,514, filed on Aug. 3, 2023, the content of which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

### SUMMARY

This disclosure relates to Layer One/Layer Two (L1/L2) based inter-cell mobility, also known as lower-layer triggered mobility (LTM), in which a user equipment (UE) is handed over from a serving cell to a target candidate cell.

In accordance with one aspect of the present disclosure, a method is provided. The method includes determining to perform a lower-layer triggered mobility (LTM) procedure from a serving cell to a target candidate cell, where the target candidate cell supports an uplink (UL) carrier and a supplementary uplink (SUL) carrier. The method includes selecting one of the UL carrier and the SUL carrier for transmitting a contention-free random access (CFRA) preamble to the target candidate cell. The method also includes transmitting, via a physical random access channel (PRACH), the CFRA preamble toward the target candidate cell using the selected one of the UL carrier and the SUL carrier.

In some implementations, selecting the one of the UL carrier and the SUL carrier includes selecting the one of the UL carrier and the SUL carrier based on a predetermined rule.

In some implementations, selecting the one of the UL carrier and the SUL carrier includes: receiving, from a base station of the serving cell, a medium access control (MAC) control element (CE) including a cell switch command (CSC); and determining, based on a field in the CSC, the one of the UL carrier and the SUL carrier.

In some implementations, the field in the CSC has one binary bit. A first value of the field in the CSC indicates the UL carrier is selected, and a second value of the field in the CSC indicates the SUL carrier is selected.

In some implementations, the method further includes: receiving a radio resource control (RRC) signal that indicates dividing one or more Control Resource Set (CORESETs) or one or more search space sets (SSSs) into a plurality of groups; and detecting, in one of the plurality of groups, a downlink control information (DCI) signal to trigger the LTM procedure, the DCI signal having a format of 1_0. Selecting the one of the UL carrier and the SUL carrier includes: in response to determining that the one of the plurality of groups is a first group, selecting the UL carrier, and in response to determining that the one of the plurality of groups is a second group, selecting the SUL carrier.

In some implementations, the method further includes: receiving a downlink control information (DCI) signal to trigger the LTM procedure; and detecting a scrambling sequence that is used to scramble the cyclic redundancy check (CRC) bits in the DCI signal.

In some implementations, selecting the one of the UL carrier and the SUL carrier includes: in response to determining that the scrambling sequence is a first scrambling sequence, selecting the UL carrier, and in response to determining that the one of the plurality of groups is a second scrambling sequence, selecting the SUL carrier.

In accordance with another aspect of the present disclosure, a method is provided for performing a contention-free random access (CFRA) in a lower-layer triggered mobility (LTM) procedure from a serving cell to a target candidate cell. The method includes transmitting a physical random access channel (PRACH) signal to the target candidate cell; and monitoring for a random access response (RAR) from the serving cell, wherein the RAR includes a timing advance value measured by the target candidate cell and forwarded to the serving cell through a backhaul link.

In some implementations, monitoring the RAR from the serving cell includes: receiving, via radio resource control (RRC) signaling and from the target candidate cell, an offset value that is determined at least based on a latency of a backhaul link from the target candidate cell to the serving cell; and determining a time window for monitoring the RAR based on the offset value and a time of transmitting the PRACH signal.

In some implementations, the offset value is measured from at least one of: a slot in which the PRACH signal is transmitted, or an ending symbol of the PRACH signal.

In some implementations, the offset value is measured in at least one of: a number of slots, a number of symbols, or a number of milliseconds.

In some implementations, monitoring the RAR from the serving cell occurs during a time window configured by the serving cell, wherein a size of the time window is greater than a maximum size of an existing time window configured by the serving cell.

In some implementations, the size of the time window configured by the serving cell is greater than 10 slots.

In some implementations, monitoring the RAR from the serving cell includes: receiving, via radio resource control (RRC) signaling and from the serving cell, (i) an offset value that is determined at least based on a latency of the backhaul link from the target candidate cell to the serving cell and (ii) the size of the time window; and determining the time window based on the offset value, the size of the time window, and a time of transmitting the PRACH signal.

In some implementations, monitoring the RAR from the serving cell includes: monitoring a UE-specific search space (USS) for a downlink control information (DCI) signal that schedules a medium access control (MAC) control element (CE), wherein the MAC CE includes the RAR; and receiving the DCI signal that schedules transmission of the MAC CE.

In some implementations, the DCI signal is a DCI format 1_0. Cyclic redundancy check (CRC) bits of the DCI signal are scrambled by a cell radio network temporary identifier (C-RNTI) in the USS.

In some implementations, the MAC CE includes a timing advance command.

In some implementations, the MAC CE includes at least one of: a physical cell identifier (ID) of the target candidate cell, or a logic ID of the target candidate cell.

In some implementations, a granularity of the timing advance value is dependent on a subcarrier spacing of a UL bandwidth part (BWP) in a first UL transmission after completion of the LTM procedure.

In some implementations, the LTM procedure is triggered by a physical downlink control channel (PDCCH) order. The RAR is received via the PDCCH. The target candidate cell includes a special cell (SpCell). The method further includes: assuming the PDCCH has a same quasi-colocation (QCL) property as a demodulation reference signal (DMRS) of the PDCCH order.

In some implementations, the LTM procedure is triggered by a physical downlink control channel (PDCCH) order. The RAR is received via the PDCCH. The target candidate cell includes a secondary cell (SCell). The method further includes: assuming the PDCCH has a same quasi-colocation (QCL) property as a type-1 common search space (CSS) of the serving cell.

In some implementations, the RAR is received via a physical downlink shared channel (PDSCH). The method further includes: assuming a demodulation reference signal (DMRS) of the PDSCH has a same quasi-colocation (QCL) property as a DMRS of a physical downlink control channel (PDCCH).

In some implementations, the method further includes: switching from the serving cell to the target candidate cell.

In accordance with yet another aspect of the present disclosure, a method is provided for performing a contention-free random access (CFRA) in a lower-layer triggered mobility (LTM) procedure from a serving cell to a target candidate cell. The method includes determining, by a user equipment (UE), that random access response (RAR) reception is not configured for the UE. The method includes receiving, by the UE, a physical downlink control channel (PDCCH) order for transmitting a physical random access channel (PRACH) signal to the target candidate cell. The method includes determining, by the UE and based on the PDCCH order, a transmission power for transmitting the PRACH signal.

In some implementations, determining the transmission power includes determining the transmission power based on: P_{Target}=P_{Rx,Target}+Δ+(n−1)×P_{Ramp}, where P_{Target} is the transmission power, P_{Rx,Target} is a target reception power for the target candidate cell to receive the PRACH signal, Δ is a parameter corresponding to a format of the PRACH signal, P_{Ramp} is a power ramping step, and n is a power ramping counter value.

In some implementations, the PDCCH order includes a field of X bits that indicates n, X being a positive integer. Also, X≤log₂M, where M is a maximum number of PRACH transmissions

In some implementations, s=n, where s is a value of the field.

In some implementations, s=n mod K, and K=2^{X}, where s is a value of the field and K is a maximum value of the field.

In some implementations, the PDCCH order includes a one-bit field that indicates whether the transmission of the PRACH signal is an initial transmission or a retransmission.

In some implementations, the method further includes: counting an accumulated number of transmissions of the PRACH signal, wherein determining the transmission power for transmitting the PRACH signal is further based on the accumulated number of transmissions of the PRACH signal.

In some implementations, the method further includes: resetting the number of transmissions of the PRACH signal upon expiration of a timer.

In some implementations, the method further includes: resetting the number of transmissions of the PRACH signal in response to at least one of: receiving another PDCCH order for performing the CFRA with candidate cell that is different from the target candidate cell, receiving another PDCCH order for performing the CFRA with the target candidate cell, or receiving a new synchronization signal block (SSB) of the target candidate cell.

In some implementations, the method further includes: transmitting the PRACH signal to the target candidate cell.

The aforementioned methods can be implemented by one or more processors or processing circuitry. In some examples, an apparatus may comprise one or more processors or processing circuitry. An apparatus may be a baseband processor. In some examples, an apparatus may be a UE or a component of a UE. The one or more processors can access a non-transitory computer readable medium to execute stored instructions that cause the apparatus to preform one or more operations of the methods.

In accordance with yet another aspect of the present disclosure, a network entity is provided. The network entity includes one or more processors configured to execute instructions that cause the network entity to perform operations. The operations include: instructing a user equipment (UE) to perform a lower-layer triggered mobility (LTM) procedure from a serving cell to a target candidate cell, wherein the target candidate cell supports an uplink (UL) carrier and a supplementary uplink (SUL) carrier; determining one of the UL carrier and the SUL carrier for receiving a contention-free random access (CFRA) preamble from the UE to the target candidate cell; and receiving, via a physical random access channel (PRACH) between the UE and the target candidate cell, the CFRA preamble using the one of the UL carrier and the SUL carrier.

In accordance with yet another aspect of the present disclosure, a network entity is provided. The network entity includes one or more processors configured to execute instructions that cause the network entity to perform operations. The operations include: causing a first base station associated with a target candidate cell to receive a physical random access channel (PRACH) signal from a user equipment (UE); causing the first base station to forward, through a backhaul link, a timing advance value to a second base station associated with a target candidate cell; and causing the second base station to transmit a random access response (RAR) to the UE, wherein the RAR includes the timing advance value.

In accordance with yet another aspect of the present disclosure, a network entity is provided. The network entity includes one or more processors configured to execute instructions that cause the network entity to perform operations. The operations include: configuring a user equipment (UE) with random access response (RAR) skipping; and causing a first base station associated with a serving cell to transmit, to the UE, a Physical Downlink Control Channel (PDCCH) order. The PDCCH order instructs the UE to transmit a Physical Random Access Channel (PRACH) signal to a second base station associated with a target candidate cell. The PDCCH order includes information that the UE uses to determine a transmission power for transmitting the PRACH signal.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates a frame structure of an example medium access control (MAC) control element (CE), according to some implementations.

FIG. 3 illustrates a frame structure of another example MAC CE, according to some implementations.

FIG. 4 illustrates a timing diagram of an example random access response (RAR) monitoring procedure, according to some implementations.

FIGS. 5A and 5B each illustrate an example scenario where a UE makes quasi-colocation (QCL) assumption, according to some implementations.

FIGS. 6A-6F each illustrate a flowchart of an example method, according to some implementations.

FIG. 7 illustrates an example UE, according to some implementations.

FIG. 8 illustrates an example access node, according to some implementations.

### DETAILED DESCRIPTION

The evolution of mobile technology calls for reducing communication latency and improving communication reliability. Recently, LTM was proposed to reduce latency, overhead, and interruption when a UE is handed over from a serving cell to a target candidate cell in a network. Compared to existing higher layer-triggered mobility, LTM allows the handover to occur via L1/L2 while reducing the delay due to higher layer signaling and/or reconfiguration. Although LTM has the prospect of improving UE mobility, several technical problems relating to LTM remain unaddressed.

As a first example of the technical problems, when a UE is handed over to a target candidate cell that supports both an uplink (UL) carrier and a supplementary UL (SUL) carrier, the network may need a mechanism to indicate to the UE the carrier to be used for triggering a Contention-Free Random Access (CFRA) preamble transmission.

As a second example, when the UE transmits a Physical Random Access Channel (PRACH) signal (e.g., using the received CFRA preamble) to the target candidate cell in the CFRA process, the target candidate cell measures a timing advance (TA) value based on the PRACH signal transmitted by UE and forwards the measured TA value to the serving cell via a backhaul link between the two cells. Considering the forwarding delay caused by the backhaul link, the network may need a mechanism to indicate to the UE a timing value to begin monitoring a PDCCH for a random access response (RAR) from the serving cell, with the RAR indicating the TA value.

As a third example, the UE's transmission of the PRACH signal in the CFRA may be triggered by a Downlink Control Information (DCI) signal with a format of, e.g., 1_0, which serves as a PDCCH order. For higher layer triggered mobility, the PDCCH order indicates a Synchronization Signal Block (SSB) or a Channel State Information Reference Signal (CSI-RS) of the serving cell, so the UE assumes that the RAR transmitted from the serving cell via a Physical Downlink Shared Channel (PDSCH) is quasi-collocated (QCLed) with the SSB or CSI-RS indicated by the PDCCH order. Different from higher layer triggered mobility, in LTM the PDCCH order indicates the SSB or CSI-RS of the target candidate cell. As such, the RAR and the PDCCH of the SSB or CSI-RS are from two different cells. Accordingly, the UE, when receiving the RAR from the serving cell, may need to make a QCL assumption that applies to LTM.

As a fourth example, in some scenarios of LTM, the network may configure the UE to skip the reception of RAR. With RAR skipping configured, after a UE transmits a PRACH signal to the target candidate cell in response to a PDCCH order, the serving cell does not transmit a RAR to the UE and the UE does not expect to receive the RAR. In scenarios where the target candidate cell does not receive the PRACH signal, the serving cell may repeat the PDCCH order to trigger one or more PRACH retransmissions. To increase the possibility that the retransmitted PRACH signal is received by the target candidate cell, the UE may follow a power ramping procedure to increase the power in each PRACH retransmission. To perform power ramping effectively and efficiently, the UE may need a mechanism to determine the power in each PRACH transmission and retransmission in response to the PDCCH order.

This disclosure provides solutions to the problems described above. With one or more features described below, implementations of this disclosure advantageously improve the robustness of LTM, and, accordingly, reduce latency in mobile communications.

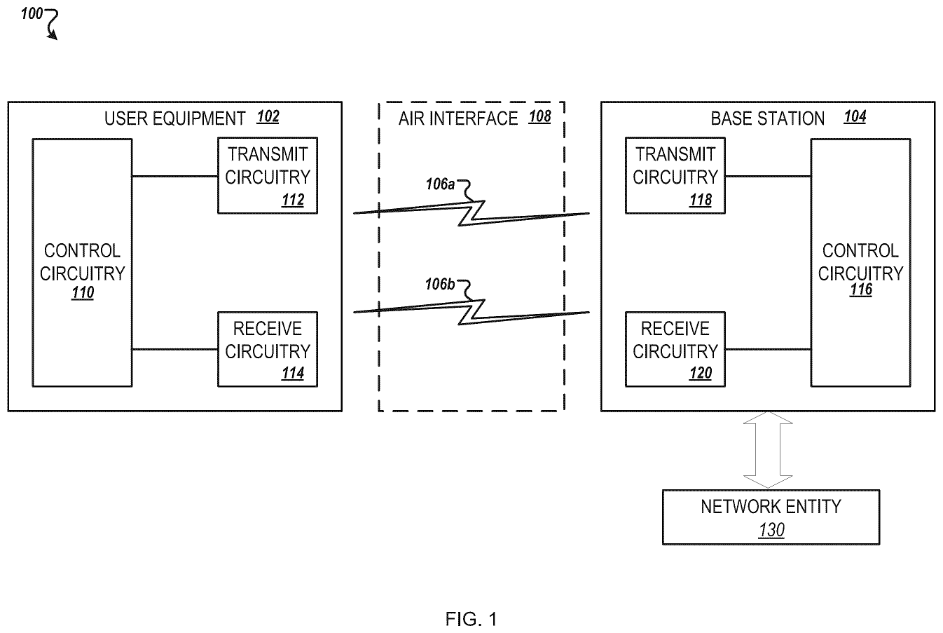

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications, such as Release 18 of the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can interact with transmit circuitry 112 and/or receive circuitry 114 to perform various operations in an LTM procedure.

The transmit circuitry 112 can perform various LTM operations described in this specification, such as transmitting a PRACH signal in CFRA. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various LTM operations described in this specification, such as receiving a PDCCH order that triggers CFRA. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and user data (e.g., messages, images, video, etc.) structured within data blocks that are carried by the physical channels.

FIG. 1 also illustrates the base station 104. The base station 104 may configure and manage one or more cells covering a geographical area. The UE 102 (and other UEs) within the coverage of a cell may access a mobile network via the cell. For example, the base station 104 may be connected to a network entity 130, such as a server of the network operator or network provider. When the UE 102 enters the geographical area covered by the cell, the UE 102 may establish communication with the network entity 130 via the base station 104 to access network service according to the UE 102's subscription. When the UE 102 is in a location simultaneously covered by multiple cells managed by multiple base stations, the UE 102 may determine which cell to use based on, e.g., communication quality with each cell, network load of each base station, and type of service provided by each base station. The cell via which the UE 102 communicates with the network entity 130 is considered a serving cell. When the UE 102 needs to change its serving cell (e.g., when the UE 102 moves to a geographical area that is not covered by its current serving cell), the UE 102 and the network can perform a handover procedure such that the UE 102 is handed over to another cell (referred to as a target candidate cell) to continue provide the UE 102 access to the network.

In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

In an LTM procedure, a UE, such as UE 102 of FIG. 1, performs random access with the network. The random access can be contention based or contention free. For contention-based random access procedures, multiple UEs can have the same preamble for PRACH transmission. For CFRA procedures, the UE transmits a signal to the target candidate cell to trigger the network to provide the UE with a preamble, designated to the UE, for PRACH transmission.

As discussed previously, in some implementations of LTM with CFRA procedures, the target candidate cell supports both an UL carrier and a SUL carrier (e.g., a carrier at a lower frequency than the UL carrier and supplemental to the UL carrier) for the UE to transmit the signal to trigger the preamble transmission. The UE can be configured with one or more options to determine whether to use the UL carrier or the SUL carrier.

In some implementations, the UE makes the selection between the UL carrier and the SUL carrier based on a predetermined rule. The rule can be, e.g., stored in the UE's memory, provided to the UE when the UE establishes communication with the network, or generated by the UE when a selection is needed.

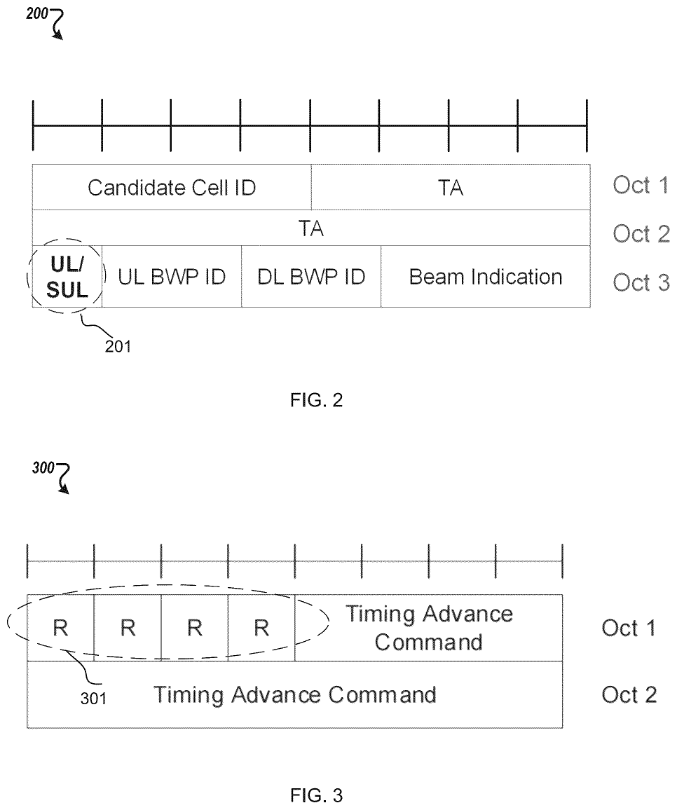

In some implementations, the UE makes the selection between the UL carrier and the SUL carrier based on a field in a PDCCH order received from the serving cell. For example, the PDCCH order can include a MAC CE that has a cell switch command (CSC). The CSC can have a field that indicates whether the UE should use the UL carrier or the SUL carrier. An example MAC CE is shown in FIG. 2.

FIG. 2 illustrates a frame structure of an example MAC CE 200 that can provide the UE with carrier selection information, according to some implementations. As shown in FIG. 2, MAC CE 200 includes three octets, Oct 1 to Oct 3. The octets can provide various information relating to the LTM procedure. In Oct 3, a one-bit field 201 is included to indicate whether the UE should use the UL carrier or the SUL carrier. When field 201 has a first value (e.g., ‘0’), the UE can determine to use the UL carrier. When field 201 has a second value (e.g., ‘1’), the UE can determine to use the SUL carrier.

In some implementations, the UE makes the selection between the UL carrier and the SUL carrier based on a control resource set (CORESET) or search space set (SSS) in which DCI (e.g., the DCI signal with a format 1_0 that triggers the PRACH transmission in the LTM) is detected. For example, the UE can be configured with one or more CORESETs, which are divided into one or more groups. If DCI is detected in a first CORESET, the UE can determine to use the UL carrier. If DCI is detected in a second CORESET, the UE can determine to use the SUL carrier. The mechanism of selection can be similarly applied for SSS groups.

In some implementations, the UE makes the selection between the UL carrier and the SUL carrier based on cyclic redundancy check (CRC) bits in the DCI signal. For example, the UE can detect a 24-bit scrambling sequence used to scramble the CRC bits. If the scrambling sequence corresponds to a first sequence (e.g., a 24-bit sequence of all ‘0’s), the UE can determine to use the UL carrier. If the scrambling sequence corresponds to a second sequence (e.g., a 24-bit sequence of all ‘1’s), the UE can determine to use the SUL carrier.

In CFRA procedures in LTM, the target candidate cell measures a TA value upon reception of the PRACH signal from the UE. The target candidate cell then forwards the TA value to the serving cell. In addition, the UE, after transmitting the PRACH signal, monitors for an RAR from the serving cell that indicates the TA value to the UE. The UE can use the TA value for other operations of LTM. The backhaul forwarding of the TA value from the target candidate cell to the serving cell typically causes a latency. For efficient operations, it is desirable for the UE to take into account the latency of the backhaul link when monitoring for the RAR that conveys the TA value. As described below, the UE can be configured with one or more options to obtain information for efficiently monitoring for the RAR, according to some implementations.

In some implementations and as a first option (Alt 1), the UE receives, from the target candidate cell and via radio resource control (RRC) signaling, an offset value. The offset can be determined by the target candidate cell based on the latency of backhaul link and can be measured in units such as number of slots, number of symbols, or number of milliseconds. The UE can use the offset value to determine a starting point of a time window for monitoring the RAR (“RAR window”). For example, the UE can determine a slot in which the PRACH signal is transmitted, wait a period that starts from the slot and equals the offset value, and begin to monitor for the RAR. In this scenario, the RAR window is measured from the slot in which the PRACH signal is transmitted. Alternatively or additionally, the UE can determine an ending symbol of the PRACH signal transmission, wait a period that starts from the ending symbol and equals the offset value, and begin to monitor for the RAR. In this scenario, the RAR window is measured from the ending symbol of the PRACH signal transmission.

In some implementations and as a second option (Alt 2), the UE extends an existing time window to allow for more time to monitor for the RAR. For example, the serving cell can configure the UE with an existing time window (e.g., for use in a non-LTM procedure) that lasts at a maximum 10 slots for licensed spectrum according to a provision of Release 17 of the 3GPP standards. In a LTM procedure, the UE can start the RAR window according to a starting point of the existing time window but determine that the RAR window lasts longer than the maximum length of the existing time window (e.g., long than 10 slots). By extending the maximum length of the existing RAR window, the UE can ensure that the RAR window is long enough to accommodate the backhaul latency.

In some implementations and as a third option (Alt 3), the UE determines the RAR window following both the first and the second options, e.g., both according to the offset value and by extending the maximum length of the existing time window. For example, the UE can determine the starting point of the RAR window according to the offset value and the PRACH signal transmission time, while determining the size of the RAR window by extending the maximum length of the existing time window. The network can use RRC signaling to configure the UE whether to follow the first option, the second option, or the first and second options combined.

In Alt 1 to Alt 3, the UE can monitor for the RAR according to monitoring occasions (MOs) specified in a common search space (CSS), such as a type-1 PDCCH CSS. Differently, in some implementations and as a fourth option (Alt 4), the UE monitors a UE-specific search space (USS) of the servicing cell for a DCI signal with the format of 1_0. The DCI signal can have CRC bits scrambled by a cell radio network temporary identifier (C-RNTI) in the USS. The DCI signal can schedule a PDSCH transmission of a MAC CE that serves as the RAR and provides the measured TA value to the UE.

FIG. 3 illustrates a frame structure of an example MAC CE 300, according to some implementations of Alt 4. As shown in FIG. 3, MAC CE 300 includes two octets, Oct 1 and Oct 2. The octets can provide various information relating to the LTM procedure. For example, in Oct 1, the four bits 301, which are conventionally reserved (marked as “R” in the FIG. 3), can indicate the physical identifier (ID) and/or the logic cell ID of the target candidate cell. In scenarios where the UE maintains (e.g., operates) only one ongoing RA procedure with the target candidate cell each time, the value of bits 301 can be omitted. In addition, the Timing Advance Command Field in Oct 1 and Oct 2 can indicate the TA value to the UE. The granularity of the TA value can depend on a subcarrier spacing (SCS) of a UL bandwidth part (BWP) to be used by the UE in its first UL transmission to the target candidate cell after completion of the LTM. For instance, the TA granularity for SCS of 15 kHz can be 520.83 ns, while the TA granularity for SCS of 30 kHz can be 260.42 ns. Further, MAC CE 300 can be structured without fields for UL grant or temporary C-RNTI (TC-RNTI) values.

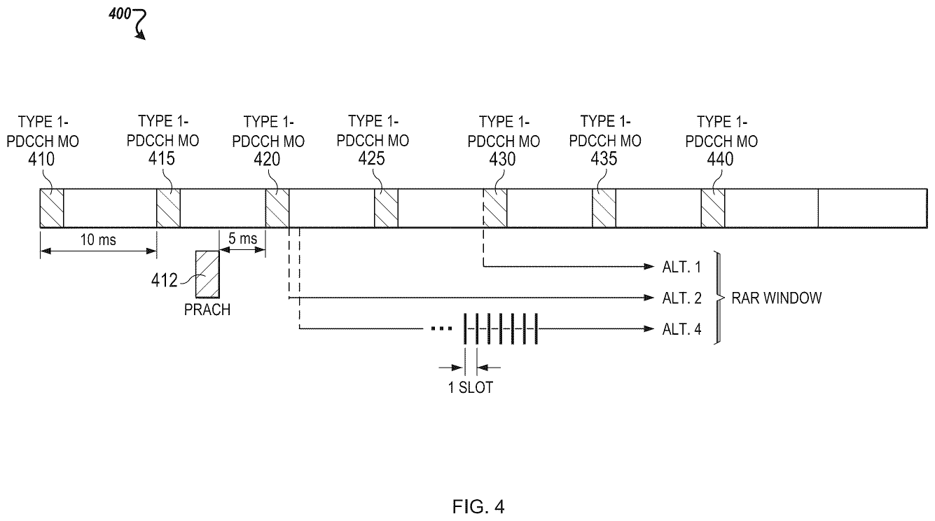

FIG. 4 illustrates a timing diagram of an example RAR monitoring procedure 400, according to some implementations. Procedure 400 can involve a UE that performs LTM to switch from a serving cell to a target candidate cell.

In the scenario illustrated, the backhaul latency is 20 milliseconds (ms) for the target candidate cell to forward the measured TA value to the serving cell. The serving cell is configured with a CSS that specifies a plurality of type-1 PDCCS MOs 410, 415, 420, . . . and 440, with a periodicity of 10 ms. In other words, each two adjacent MOs have a time difference of 10 ms. Additionally, transmission of PRACH signal 412 is triggered at a time between MO 415 and MO 420, with the ending symbol of the transmission happens 5 ms in advance of the start of MO 420.

For a UE implementing Alt 1, the serving cell can transmit an RRC signal to the UE to indicate the offset value. Assuming the offset value is 20 ms, the UE can start monitoring for the RAR at a MO that occurs at least 20 ms after the ending symbol of PRACH signal 412. In the illustrated scenario, because MOs 420, 425, and 430 occur 5 ms, 15 ms, and 25 ms, respectively, after the ending symbol of PRACH signal 412, the UE can determine to start monitoring for the RAR at the beginning of MO 420.

For a UE implementing Alt 2, the UE can start monitoring for the RAR at a next MO immediately following the PRACH transmission. For example, the UE can start monitoring for the RAR at the beginning of MO 420. Assuming the UE is configured to extend the existing time window to 30 ms to account for backhaul latency, the UE can keep monitoring for the RAR for a duration of 30 ms starting from MO 420.

For a UE implementing Alt 3 (i.e., Alt 1 combined with Alt 2), the UE can determine when to start monitoring for the RAR and how long the monitoring lasts according to the descriptions above with respect to Alt 1 and Alt 2, respectively.

For a UE implementing Alt 4, the UE monitors a USS, instead of the CSS, of the serving cell, for a MAC CE, such as MAC CE 300, that serves as the RAR. The UE can start monitoring for the MAC CE at a slot following the transmission of PRACH signal 412. Because the time distance between two adjacent slots in the USS is typically much smaller than time distance between two adjacent MOs in the CSS, it is possible that the UE implementing Alt 4 receives the TA value at a much earlier time than a UE implementing any of Alt 1 to Alt 3.

A UE performing CFRA in LTM may need to make a QCL assumption when receiving the RAR either via a PDCCH (such as in scenarios where the UE implements any of Alt 1 to Alt 3) or via a PDSCH (such as in scenarios where the UE implements Alt 4). Depending on the type of the target candidate cell in the LTM procedure, the RAR reception can fall in one of several cases.

In some implementations and according to a first case, the RAR is received via a PDCCH and the target candidate cell is a special cell (SpCell). In this case, the UE assumes that the PDCCH has the same QCL property as a demodulation reference signal (DMRS) of the PDCCH order that triggers the CFRA. In other words, when the UE, triggered by a PDCCH order to perform LTM, monitors a PDCCH for an RAR, the UE can assume that the RAR is transmitted via the PDCCH that has the same QCL property as a DMRS corresponding to the PDCCH order.

In some implementations and according to a second case, the RAR is received via a PDCCH and the target candidate cell is a secondary cell (SCell). In this case, the UE assumes that the PDCCH has the same QCL property as a type-1 CSS of the serving cell, such as the CSS in which MOs 410, 415, . . . and 440 are configured. In other words, when the UE monitors the type-1 CSS of the serving cell for receiving an RAR, the UE can assume that the RAR is transmitted via a PDCCH that has the same QCL property as the CSS.

In some implementations and according to a third case, the RAR is received via a PDSCH, such as the PDSCH via which MAC CE 300 is transmitted in Alt 4. In this case, the UE assumes that a DMRS of the PDSCH has the same QCL property as a DMRS of the PDCCH if the RAR were to be received via the PDCCH. In other words, whether the UE implements Alt 1 to Alt 3 to receive the RAR via a PDCCH or implements Alt 4 to receive the RAR via a PDSCH, the UE makes QCL assumption based on the type of the target candidate cell (e.g., SCell or SpCell), as previously described in the first case and the second case.

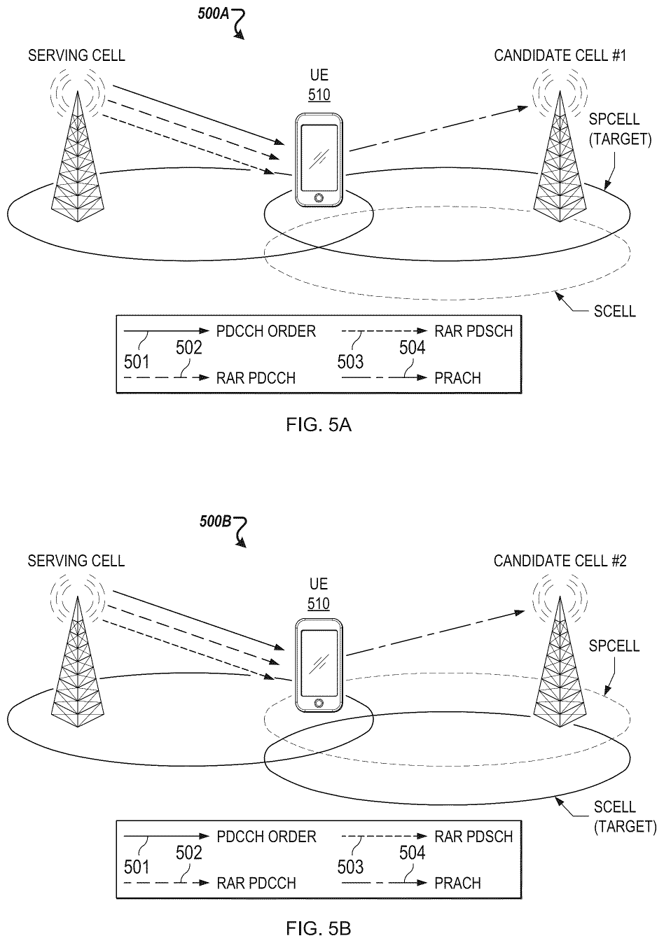

To explain, FIGS. 5A and 5B each illustrate an example scenario, 500A and 500B, respectively, where a UE makes QCL assumption, according to some implementations. In each of scenarios 500A and 500B, UE 510, upon receiving PDCCH order 501, performs CFRA in LTM to switch from a serving cell to a target candidate cell, which is one of two candidate cells #1 and #2. Candidate cell #1 is an SpCell. Candidate cell #2 is an SCell.

In scenario 500A, candidate cell #1 is the target candidate cell. Accordingly, UE 510 transmits PRACH signal 504 to candidate cell #1 and monitors for the RAR from the serving cell. Whether the RAR is received via PDCCH 502 or PDSCH 503, UE 510 makes QCL assumption according to the first case. In other words, UE 510 assumes that RAR transmission has the same QCL property as the DMRS of PDCCH order 501.

In scenario 500B, candidate cell #2 is the target candidate cell. Accordingly, UE 510 transmits PRACH signal 504 to candidate cell #2 and monitors for the RAR from the serving cell. Whether the RAR is received via PDCCH 502 or PDSCH 503, UE 510 makes QCL assumption according to the second case. In other words, UE 510 assumes that RAR transmission has the same QCL property as the CSS of the serving cell.

As previously discussed, a UE performing LTM may be configured with RAR skipping and may follow a power ramping procedure to retransmit the PRACH signal upon receiving one or more PDCCH orders from the serving cell. The PRACH transmission power in the power ramping procedure can be determined based on the following equation:

$${P}_{Target} = {P}_{Rx , Target} + Δ + ( n - 1 ) \times {P}_{R amp} ,$$

where P_{Target} is the transmission power, P_{Rx,Target} is a target reception power for the target candidate cell to receive the PRACH signal, Δ is a parameter corresponding to a format of the PRACH signal, P_{Ramp} is a power ramping step, and n is a power ramping counter value.

Among the variables for the UE to determine P_{Target}, P_{Rx,Target} can be specified by the target candidate cell and communicated to the UE, Δ can be a constant depending on the PRACH signal format, P_{Ramp} can be configured by higher layers as a step size in the power ramping procedure, and n can indicate the accumulated number of PRACH transmissions for a given SSB of the target candidate cell, with n=1 indicating the first transmission after the triggering of CFRA.

In some implementations, the UE determines the value of n from the PDCCH order that triggers the PRACH transmission or retransmission. For example, the PDCCH order can have a field of X bits (X is a positive integer) to indicate n. The X bits can include one or more bits that are conventionally reserved according to, e.g., earlier releases of the 3GPP standards.

Table 1 provides a first example of using an X-bit field to indicate the value of n. In the example of Table 1, the value s of the X-bit field equals the value n. In other words, the X-bit field of the PDCCH order indicates to the UE the exact value of the accumulated number of PRACH transmissions up to a maximum value K of the X-bit field.

TABLE 1

| Value of s | Value of n |
|---|---|
| 1 | 1 |
| 2 | 2 |
| 3 | 3 |
| . . . | . . . |
| K | K |

Table 2 provides a second example of using an X-bit field to indicate the value of n. Different from the one-to-one correspondence between s and n in Table 1, in the example of Table 2, the same value of s can correspond to multiple values of n. For example, the values of s, n, K, and X can follow s=n mod K, and

$$s = n mod K , and$$

$$K = {2}^{X} .$$

Accordingly, in the example of Table 2, the same value of s=1 corresponds to n=1 and n=5, the same value of s=2 corresponds to n=2 and n=6, and so forth. Although the UE, upon receiving a PDCCH order with the X-bit field, cannot affirmatively determine the exact number of accumulated PRACH transmissions (e.g., the UE cannot tell whether n=1 or n=5 from s=1), the risk of the UE improperly setting the transmission power is practically insignificant. This is because, as previously described, the power ramping procedure may only be needed when the target candidate cell fails to receive the PRACH signal transmitted by the UE. Because the likelihood of repeated failures is insignificant, it is rare for n to increase to a level that can cause ambiguity for determining the actual retransmission attempts. Using Table 2 as an example, the likelihood of the UE missing four consecutive PDCCH orders that trigger PRACH retransmissions is insignificant and usually negligible. Therefore, assuming the PRACH (re)transmission attempts accumulated by UE itself is N, the UE already knows that the next PDCCH-ordered (re)transmission is the X-th transmission, where X>N. Thus, when the UE has accumulated N=4 transmissions, and UE receives s=1 from a PDCCH order, the UE can assume that the actual retransmission attempt is the fifth (n=5) instead of the first (n=1). In another example, when the UE has accumulated N=1 transmission, and UE receives s=2 from a PDCCH order, the UE can assume that the actual retransmission attempt is the second (n=2), despite there is very low likelihood that UE in fact missed four consecutive PDCCH retransmissions and the correct actual retransmission attempt is the sixth (n=6).

TABLE 2

| Value of s | Value of n |
|---|---|
| 1 | 1, 5 |
| 2 | 2, 6 |
| 3 | 3, 7 |
| 4 | 4, 8 |

The indication mechanism illustrated in Table 1 uses one value of s to indicate a single value of n. The indication mechanism illustrated in Table 2, on the other hand, uses one value of s to indicate multiple values of n. Comparing the two mechanisms, the mechanism of Table 1 can reduce overhead (e.g., the number of bits transmitted in the PDCCH order for indicating n) in the PDCCH order transmission. To explain, assuming M is the maximum number of PRACH transmissions that the UE is allowed to perform, a number of X=log₂M bits are needed to cover all possible values of s=n, from 1 to M, under the mechanism of Table 1. By contrast, because s=n mod K, and K=2^{X} under the mechanism of Table 2, fewer different values of s are needed to cover all possible values of n, from 1 to M. For example, assuming M=8, eight different values of s are needed under the mechanism of Table 1, so X=3 bits are needed to cover all indications from s=1 (e.g., using ‘000’ to indicate n=1) to s=8 (e.g., using ‘111’ to indicate n=8). By contrast, four different values of s are needed under the mechanism of Table 2, so X=2 bits are needed to cover all indications from s=1 (e.g., using ‘00’ to indicate n=1 or n=5) to s=4 (e.g., using ‘11’ to indicate n=4 or n=8). In some implementations, the network can communicate with the UE in advance to determine which mechanism the servicing cell will use to indicate n.

Whether the mechanism of Table 1 or the mechanism of Table 2 is used to indicate n, the accumulation (e.g., counting of PDCCH-ordered PRACH transmissions, n) can be performed by the network (e.g., the target candidate cell and/or the serving cell). Differently, in some implementations, the PDCCH order does not indicate the value of n, and it is up for the UE to determine the value of n by, e.g., counting the number of PRACH transmissions. This way, the signaling overhead in the PDCCH order can be reduced. For example, the serving cell can include in the PDCCH order a one-bit field to indicate whether the PDCCH-ordered PRACH transmission is an initial transmission (e.g., a first PRACH transmission after the triggering of CFRA) or a retransmission. Based on the value of the one-bit field, the UE can determine the value of n and use the value of n to calculate the transmission power. In some implementations, the UE keeps counting the number of PDCCH-ordered PRACH transmissions n and increases the transmission power accordingly. In some implementations, the UE sets a cap of n and stops increasing the transmission power once the capped number of PRACH transmissions is reached.

In some implementations, the UE can reset the value of n to a certain value, e.g., 1. For example, the UE can start a timer, powerResetTimer, upon receiving a PDCCH order containing DCI that triggers an initial PRACH transmission. Upon expiration of the powerResetTimer timer, the UE can reset the value of n. Alternatively or additionally, the UE can reset the value of n upon detecting one or more conditions are met. As a first example condition, the UE receives a PDCCH order that triggers CFRA with a candidate cell that is different from the target candidate cell. As a second example condition, the UE receives a PDCCH order that triggers CFRA with the same target candidate cell. As a third example condition, the UE receives a new SSB (as opposed to a previously-received SSB when the CFRA was triggered) of the same target candidate cell. It is noted that which condition(s) a UE adopts for resetting n can depend on implementations. For example, while some UEs may reset n upon detecting the third example condition is met, some other UEs may keep n unchanged upon detecting the same condition is met.

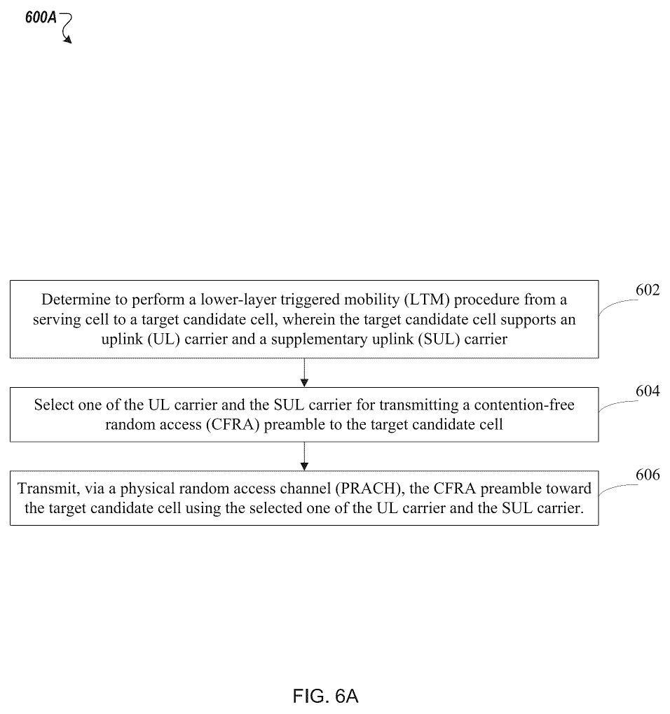

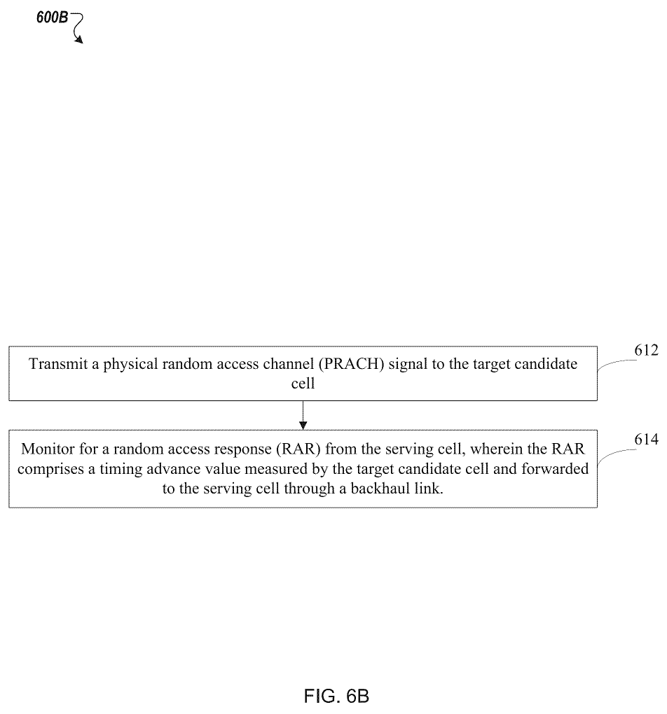

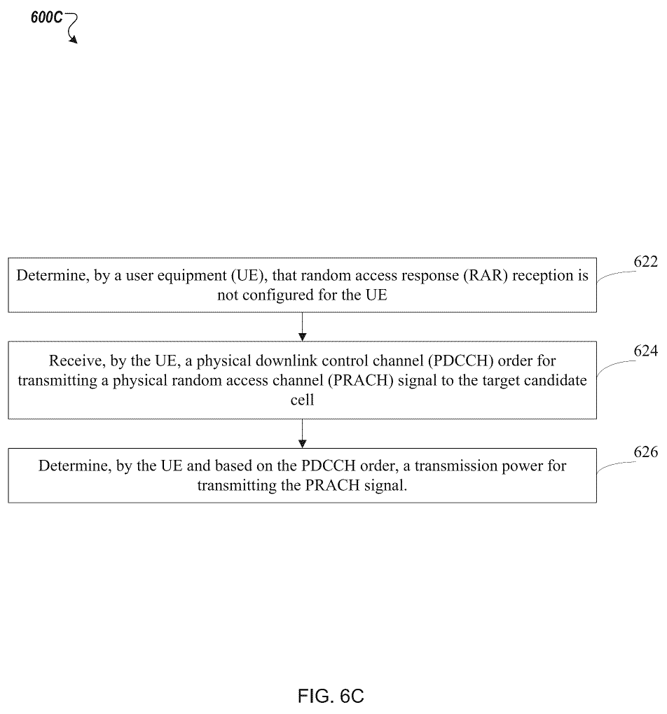

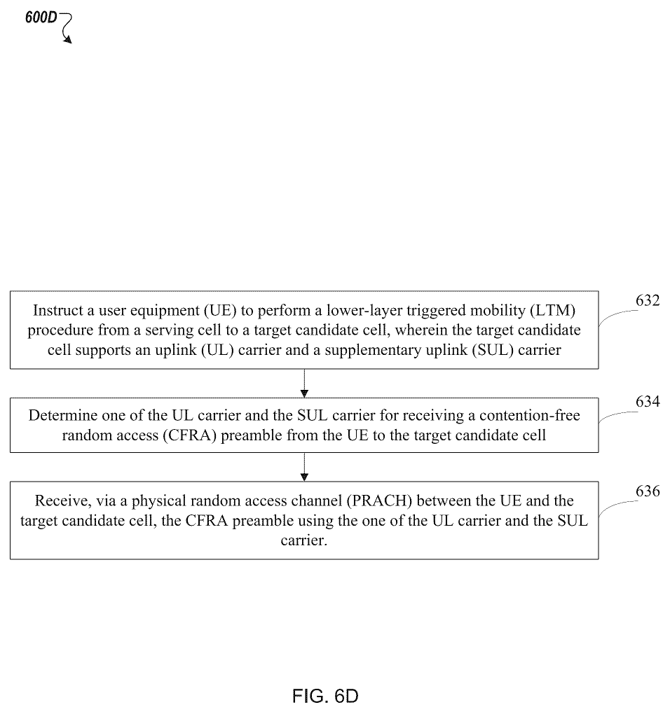

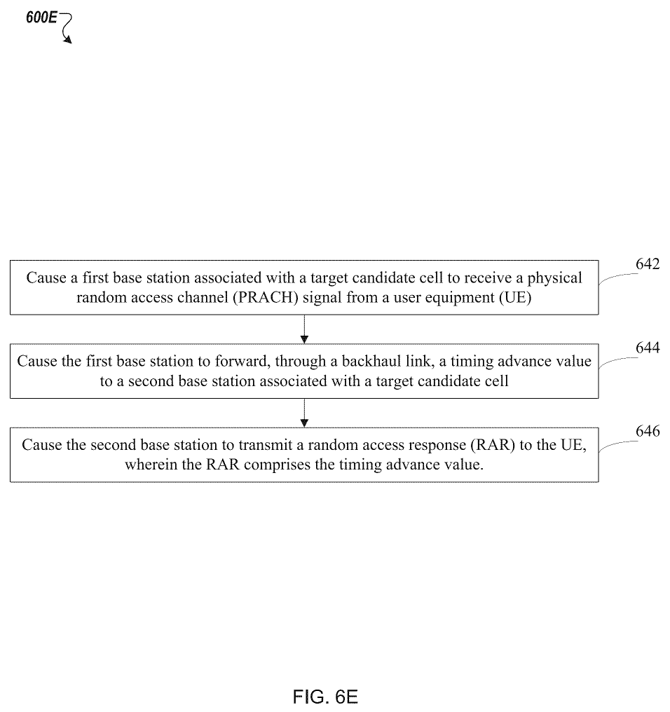

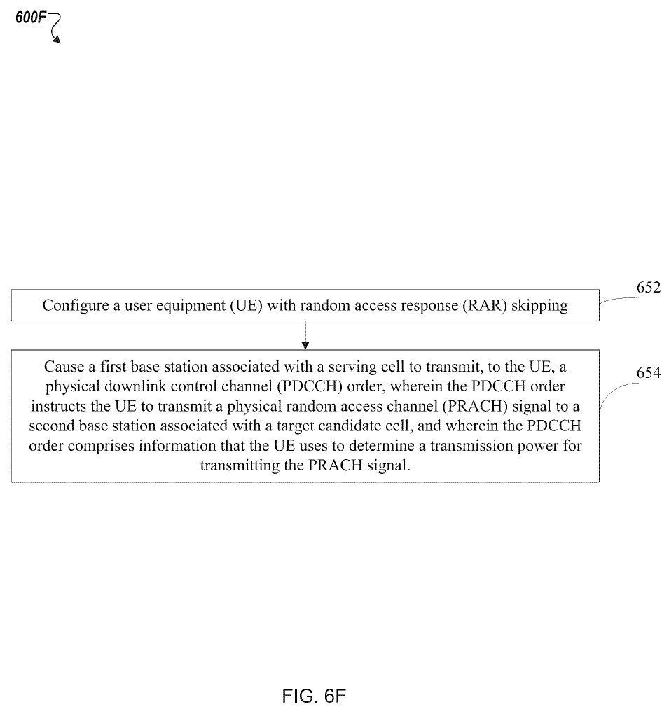

FIG. 6A illustrates a flowchart of an example method 600A, according to some implementations. For clarity of presentation, the description that follows generally describes method 600A in the context of the other figures in this description. For example, method 600A can be performed by UE 102 of FIG. 1. It will be understood that method 600A can be performed, for example, by any suitable system, environment, software, hardware, or a combination of systems, environments, software, and hardware, as appropriate. In some implementations, various steps of method 600A can be run in parallel, in combination, in loops, or in any order.

At 602, method 600A involves determining to perform an LTM procedure from a serving cell to a target candidate cell. The target candidate cell supports a UL carrier and an SUL carrier.

At 604, method 600A involves selecting one of the UL carrier and the SUL carrier for transmitting a CFRA preamble to the target candidate cell. The UE can be configured with one or more options to make the selection, such as based on a field in a MAC CE, as previously described with reference to FIG. 2.

At 606, method 600A involves transmitting, via a PRACH, the CFRA preamble toward the target candidate cell using the selected one of the UL carrier and the SUL carrier.

FIG. 6B illustrates a flowchart of an example method 600B, according to some implementations. For clarity of presentation, the description that follows generally describes method 600B in the context of the other figures in this description. For example, method 600B can be performed by UE 102 of FIG. 1. It will be understood that method 600B can be performed, for example, by any suitable system, environment, software, hardware, or a combination of systems, environments, software, and hardware, as appropriate. In some implementations, various steps of method 600B can be run in parallel, in combination, in loops, or in any order.

At 612, method 600B involves transmitting a PRACH signal to a target candidate cell in CFRA of an LTM procedure.

At 614, method 600B involves monitoring for a RAR from the serving cell. The RAR includes a TA value measured by the target candidate cell and forwarded to the serving cell through a backhaul link. The UE can determine a timing of the monitoring according to one or more of Alt 1 to Alt 4, as previously described with reference to FIGS. 3 and 4. Also, the UE receiving the RAR can make an QCL assumption similar to those previously described with reference to FIGS. 5A and 5B.

FIG. 6C illustrates a flowchart of an example method 600C, according to some implementations. For clarity of presentation, the description that follows generally describes method 600C in the context of the other figures in this description. For example, method 600C can be performed by UE 102 of FIG. 1. It will be understood that method 600C can be performed, for example, by any suitable system, environment, software, hardware, or a combination of systems, environments, software, and hardware, as appropriate. In some implementations, various steps of method 600C can be run in parallel, in combination, in loops, or in any order.

At 622, method 600C involves determining, by a UE configured to perform CFRA in an LTM procedure, that RAR reception is not configured for the UE. In other words, the UE is configured with RAR skipping.

At 624, method 600C involves receiving, by the UE, a PDCCH order for transmitting a PRACH signal to the target candidate cell.

At 626, method 600C involves determining, by the UE and based on the PDCCH order, a transmission power for transmitting the PRACH signal. The determination of the transmission power can involve, e.g., a power ramping procedure as previously described.

FIG. 6D illustrates a flowchart of an example method 600D, according to some implementations. For clarity of presentation, the description that follows generally describes method 600D in the context of the other figures in this description. For example, method 600D can be performed by network entity 130 of FIG. 1. It will be understood that method 600D can be performed, for example, by any suitable system, environment, software, hardware, or a combination of systems, environments, software, and hardware, as appropriate. In some implementations, various steps of method 600D can be run in parallel, in combination, in loops, or in any order.

At 632, method 600D involves instructing a UE to perform an LTM procedure from a serving cell to a target candidate cell. The target candidate cell supports a UL carrier and an SUL carrier.

At 634, method 600D involves determining one of the UL carrier and the SUL carrier for receiving a CFRA preamble from the UE to the target candidate cell.

At 636, method 600D involves receiving, via a PRACH between the UE and the target candidate cell, the CFRA preamble using the one of the UL carrier and the SUL carrier.

FIG. 6E illustrates a flowchart of an example method 600E, according to some implementations. For clarity of presentation, the description that follows generally describes method 600E in the context of the other figures in this description. For example, method 600E can be performed by network entity 130 of FIG. 1. It will be understood that method 600E can be performed, for example, by any suitable system, environment, software, hardware, or a combination of systems, environments, software, and hardware, as appropriate. In some implementations, various steps of method 600E can be run in parallel, in combination, in loops, or in any order.

At 642, method 600E involves causing a first base station associated with a target candidate cell to receive a PRACH signal from a UE.

At 644, method 600E involves causing the first base station to forward, through a backhaul link, a TA value to a second base station associated with a target candidate cell.

At 646, method 600E involves causing the second base station to transmit a RAR to the UE. The RAR includes the TA value.

FIG. 6F illustrates a flowchart of an example method 600F, according to some implementations. For clarity of presentation, the description that follows generally describes method 600F in the context of the other figures in this description. For example, method 600F can be performed by network entity 130 of FIG. 1. It will be understood that method 600F can be performed, for example, by any suitable system, environment, software, hardware, or a combination of systems, environments, software, and hardware, as appropriate. In some implementations, various steps of method 600F can be run in parallel, in combination, in loops, or in any order.

At 652, method 600F involves configuring a UE with RAR skipping.

At 654, method 600F involves causing a first base station associated with a serving cell to transmit, to the UE, a PDCC order. The PDCCH order instructs the UE to transmit a PRACH signal to a second base station associated with a target candidate cell. The PDCCH order includes information that the UE uses to determine a transmission power for transmitting the PRACH signal.

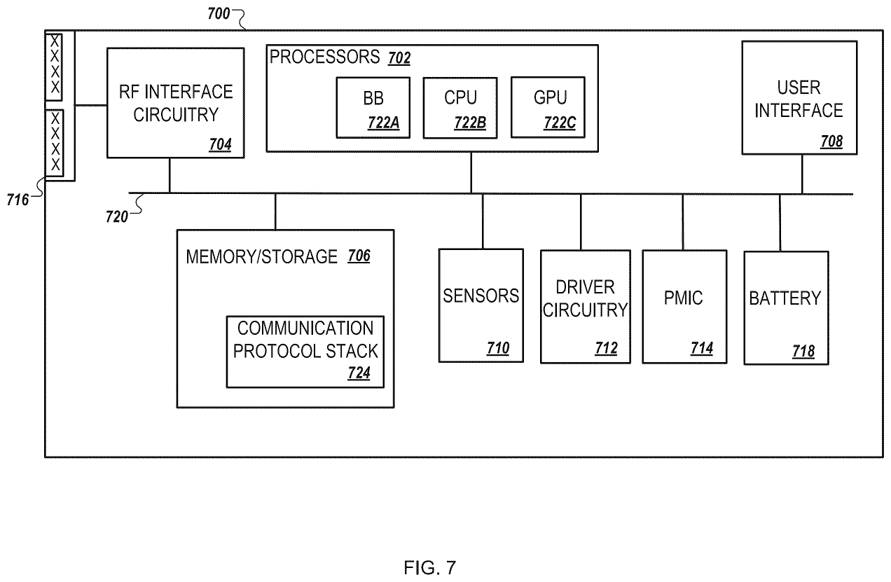

FIG. 7 illustrates an example UE 700, according to some implementations. The UE 700 may be similar to and substantially interchangeable with UE 102 of FIG. 1.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, antenna structure 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensor circuitry 728 and control and allow access to sensor circuitry 728, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

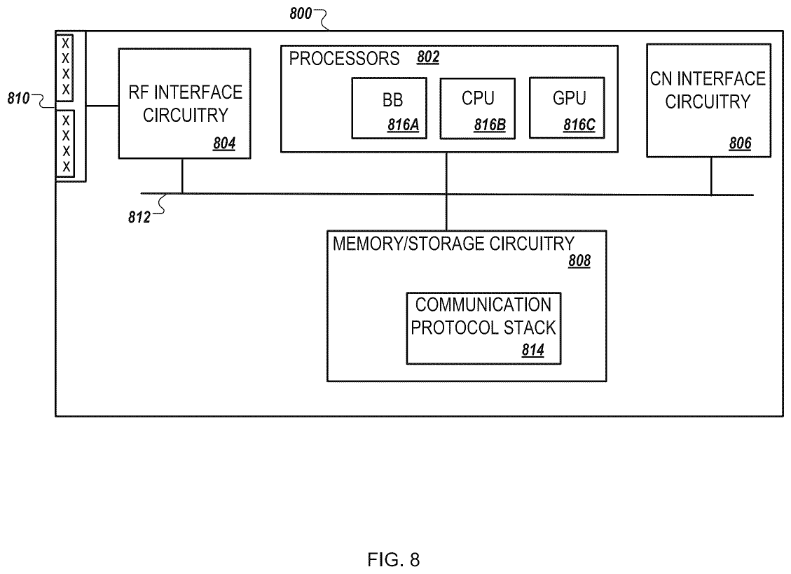

FIG. 8 illustrates an example access node 800 (e.g., a base station or gNB), according to some implementations. The access node 800 may be similar to and substantially interchangeable with base station 104. The access node 800 may include processors 802, RF interface circuitry 804, core network (CN) interface circuitry 806, memory/storage circuitry 808, and antenna structure 810. The access node 800 may be implemented as a base station associated with a serving cell or a base station associated with a target candidate cell in an LTM procedure.

The components of the access node 800 may be coupled with various other components over one or more interconnects 812. The processors 802, RF interface circuitry 804, memory/storage circuitry 808 (including communication protocol stack 814), antenna structure 810, and interconnects 812 may be similar to like-named elements shown and described with respect to FIG. 7. For example, the processors 802 may include processor circuitry such as, for example, baseband processor circuitry (BB) 816A, CPU 816B, and GPU 816C.

The CN interface circuitry 806 may provide connectivity to a network entity, such as a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method for performing a contention-free random access (CFRA) in a lower-layer triggered mobility (LTM) procedure from a serving cell to a target candidate cell, the method comprising:
determining, by a user equipment (UE), that random access response (RAR) reception is not configured for the UE;
receiving, by the UE, a physical downlink control channel (PDCCH) order for transmitting a physical random access channel (PRACH) signal to the target candidate cell; and
determining, by the UE and based on the PDCCH order, a transmission power for transmitting the PRACH signal.

2. The method of claim 1, wherein determining the transmission power comprises determining the transmission power based on:
$${P}_{Target} = {P}_{Rx , Target} + Δ + ( n - 1 ) \times {P}_{R amp} ,$$
where P_{Target} is the transmission power, P_{Rx,Target} is a target reception power for the target candidate cell to receive the PRACH signal, Δ is a parameter corresponding to a format of the PRACH signal, P_{Ramp} is a power ramping step, and n is a power ramping counter value.

3. The method of claim 2, wherein
the PDCCH order comprises a field of X bits that indicates n, X being a positive integer, and
X≤log₂M, where M is a maximum number of PRACH transmissions.

4. The method of claim 3, wherein s=n, where s is a value of the field.

5. The method of claim 3, wherein s=n mod K, and K=2^{X}, where s is a value of the field and K is a maximum value of the field.

6. The method of claim 1, wherein the PDCCH order comprises a one-bit field that indicates whether the transmission of the PRACH signal is an initial transmission or a retransmission.

7. The method of claim 6, further comprising: counting an accumulated number of transmissions of the PRACH signal, wherein determining the transmission power for transmitting the PRACH signal is further based on the accumulated number of transmissions of the PRACH signal.

8. The method of claim 7, further comprising: resetting the number of transmissions of the PRACH signal upon expiration of a timer.

9. The method of claim 7, further comprising: resetting the number of transmissions of the PRACH signal in response to at least one of:
receiving another PDCCH order for performing the CFRA with candidate cell that is different from the target candidate cell,
receiving another PDCCH order for performing the CFRA with the target candidate cell, or
receiving a new synchronization signal block (SSB) of the target candidate cell.

10. The method of claim 1, further comprising: transmitting the PRACH signal to the target candidate cell.

11. An apparatus comprising:
one or more processors; and
memory configured to store instructions that, when executed, cause the apparatus to perform operations of a contention-free random access (CFRA) in a lower-layer triggered mobility (LTM) procedure from a serving cell to a target candidate cell, the operations comprising:
determining that random access response (RAR) reception is not configured for a user equipment (UE);
receiving a physical downlink control channel (PDCCH) order for transmitting a physical random access channel (PRACH) signal to the target candidate cell; and
determining, based on the PDCCH order, a transmission power for transmitting the PRACH signal.

12. The apparatus of claim 11, wherein determining the transmission power comprises determining the transmission power based on:
$${P}_{Target} = {P}_{Rx , Target} + Δ + ( n - 1 ) \times {P}_{R amp} ,$$
where P_{Target} is the transmission power, P_{Rx,Target} is a target reception power for the target candidate cell to receive the PRACH signal, A is a parameter corresponding to a format of the PRACH signal, P_{Ramp} is a power ramping step, and n is a power ramping counter value.

13. The apparatus of claim 12, wherein
the PDCCH order comprises a field of X bits that indicates n, X being a positive integer, and
X≤log₂M, where M is a maximum number of PRACH transmissions.

14. The apparatus of claim 13, wherein s=n, where s is a value of the field.

15. The apparatus of claim 13, wherein s=n mod K, and K=2^{X}, where s is a value of the field and K is a maximum value of the field.

16. The apparatus of claim 11, wherein the PDCCH order comprises a one-bit field that indicates whether the transmission of the PRACH signal is an initial transmission or a retransmission.

17. The apparatus of claim 16, the operations further comprising: counting an accumulated number of transmissions of the PRACH signal, wherein determining the transmission power for transmitting the PRACH signal is further based on the accumulated number of transmissions of the PRACH signal.

18. The apparatus of claim 17, the operations further comprising: resetting the number of transmissions of the PRACH signal upon expiration of a timer.

19. The apparatus of claim 17, the operations further comprising: resetting the number of transmissions of the PRACH signal in response to at least one of:
receiving another PDCCH order for performing the CFRA with candidate cell that is different from the target candidate cell,
receiving another PDCCH order for performing the CFRA with the target candidate cell, or
receiving a new synchronization signal block (SSB) of the target candidate cell.

20. A network entity comprising one or more processors configured to execute instructions that cause the network entity to perform operations in a lower-layer triggered mobility (LTM) procedure, the operations comprising:
configuring a user equipment (UE) with random access response (RAR) skipping; and
causing a first base station associated with a serving cell to transmit, to the UE, a physical downlink control channel (PDCCH) order, wherein the PDCCH order instructs the UE to transmit a physical random access channel (PRACH) signal to a second base station associated with a target candidate cell, and wherein the PDCCH order comprises information that the UE uses to determine a transmission power for transmitting the PRACH signal.
